(19) United States
(12) Patent Application Publication
(10) Pub. No.: US 2005/0206517 A1
(43) Pub. Date: Sep. 22, 2005

(54) Two-wire dome light power and control system

(75) Inventor: Angelo Arcaria, Wethersfield, CT (US)

Correspondence Address: BAKER & HOSTETLER LLP;Washington Square, Suite 1100, 1050 Connecticut Avenue, N.W., WASHINGTON, DC, 20036, US

(73) Assignee: Edwards Systems Technology, Inc.

(21) Appl. No.: 10/802,916

(22) Filed: Mar. 18, 2004

(51) Int. Cl. G08B 1/08

(52) U.S. Cl. 340/538; 340/310.01; 340/286.02

(57) ABSTRACT

A display system includes a dome light with a data receiver, a user control station with a data transmitter, a power supply furnishing low-voltage AC power to the control station, and a two-wire interconnecting cable between the transmitter and receiver can provide an essentially unlimited number of distinct lamp control functions rather than being limited to the number possible in a switch-per-lamp system. Using a digital message, the receiver can identify separate commands for a large number of indicators in the dome light assembly. By using the same two-wire interconnecting cable both for power and for data transmission, interconnection complexity can be minimized without limiting flexibility. For example, it is possible with this system to replace a dome light assembly with a different one that features additional lamps without needing to rewire the installation. The system can be implemented using shielded twisted pair cable, minimizing EMI and thereby enhancing safety in a medical or research environment.

### FIELD OF THE INVENTION

The present invention relates generally to illuminated display indicators. More particularly, the present invention relates to a method and apparatus for operating a multiple lamp display indicator from a control station.

### BACKGROUND OF THE INVENTION

Existing annunciator lamp technology, including devices known in the art as dome lights, and further including those for medical applications, may use multiple wires from each served examination or patient room to light multiple lamps within a dome light at a location outside the door of the patient room. There may, in some applications, be one wire per lamp with a common return. This affords moderate complexity at each room, since there are likely to be four or more informational signals that can be sent from each room plus an emergency signal.

Each in-room controller in a typical prior-art system may feature a transmitting control station with a switch and a confirming light on the control station for each signal. There may further be a pull cord activating a switch for an emergency signal. Each switch closure may send power from a power supply to a corresponding lamp on the dome light assembly, then to a common return. It is understood that a similar system with two dedicated wires per switch closure could also be implemented, at further cost in wiring complexity.

Such an annunciator system may be highly reliable and electrically obvious, but may represent a significant cost in installation materials and labor as well as complexity.

Accordingly, what is needed in dome light systems is a technology that preserves reliability while decreasing installation complexity.

### SUMMARY OF THE INVENTION

It is therefore a feature and advantage of some embodiments of the present invention to provide a dome light system capable of illuminating individual lamps under the control of and at a display remote from a control station, using minimal wiring to achieve full functionality.

It is also a feature and advantage of some embodiments of the present invention to provide a dome light system wherein a single two-wire signal line furnishes both power and digital commands from a control station to a dome light.

The above and other features and advantages are achieved through the use of a novel dome light system and method of operation as herein disclosed. In accordance with one embodiment of the present invention, a dome light system is provided. The dome light system includes a controller with a transmitting device for power and data, at least one dome light located separately from the controller, having at least one illuminating device therein, and having a receiving device for power and data.

In accordance with another embodiment of the present invention, a dome light comprises a display device with a multiplicity of identifiably distinct display elements, a receiving device that generates a multiplicity of display modes to control the display device in response to the detection by the receiving device of a multiplicity of distinct, digitally encoded display commands, and a transmitting device, wherein the transmitting device generates the display commands recognizable by the receiving device.

In accordance with yet another embodiment of the present invention, a dome light comprises displaying means for displaying a multiplicity of identifiably distinct status elements, receiving means for receiving commands directing display in one of a multiplicity of modes of each of the identifiably distinct status elements in response to the detection by the receiving device of a multiplicity of distinct, digitally encoded display commands, and transmitting means for transmitting commands, wherein the transmitting means generates display commands recognizable by the receiving means.

In accordance with still another embodiment of the present invention, visually indicating status at a distance from a controller comprises the steps of displaying a multiplicity of identifiably distinct status elements, receiving commands directing display in one of a multiplicity of modes by each of the identifiably distinct status elements in response to the receiving of a multiplicity of distinct display commands, and transmitting display commands.

There have thus been outlined, rather broadly, some of the features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram showing a multiplicity of dome light control systems in accordance with one embodiment of the invention.

FIG. 2 is a diagram showing a front face and an internal face of a control station assembly in accordance with one embodiment of the invention.

FIG. 3 is a diagram showing a front face and an internal face of a multi-lamp dome light assembly in accordance with one embodiment of the invention.

FIG. 4 is a schematic diagram showing a portion of a dual use control station or dome light assembly transmitter or receiver circuit board in accordance with one embodiment of the invention.

FIG. 5 is a signal waveform diagram showing the timing and voltage features of the interunit signals within a dome light control system in accordance with one embodiment of the invention.

FIG. 6 is a representative signal waveform showing a signal from a representative control station assembly to a representative dome light.

### DETAILED DESCRIPTION OF PREFERRED EMBODIMENTS OF THE INVENTION

Established annunciator technology for environments such as doctors' offices, clinics, and primary care facilities may have provisions for identifying the status of individual patient rooms, such as by the presence of file folders in a basket outside the door. More technologically elaborate solutions may include, for example, a single lamp outside a patient room controlled by a switch inside the room. All such basic solutions have limited utility and none provides emergency support. More elaborate lamp-based indicator systems, to include those with two or more lamps in a dome light assembly, can include complex control wiring, possibly requiring one or more wires per lamp. Such systems may lack the ability to support enhancements without altering or adding wiring.

An exemplary embodiment of the present invention may include at least one lamp in a dome light assembly that can be affixed outside a patient's room in a medical clinic, for example, which dome light assembly can be controlled from a control station inside the same room. The dome light assembly may receive both power and control signals on a single wire pair from the control station. It may be desirable for the single wire pair providing power and control to be implemented using multiplexed control signals, contained, for example, in a serial digital command string. This is particularly true for feature-rich dome light assemblies. Some such assemblies can include more than one lamp. In some, the individual display elements within the dome light can be provided with filters, different color light emitting diodes (LEDs), or equivalent features to permit emission in different colors. In some, the lamp can emit using heightened-alert features such as flashing. In some, the dome light assembly can include capability for emitting sound.

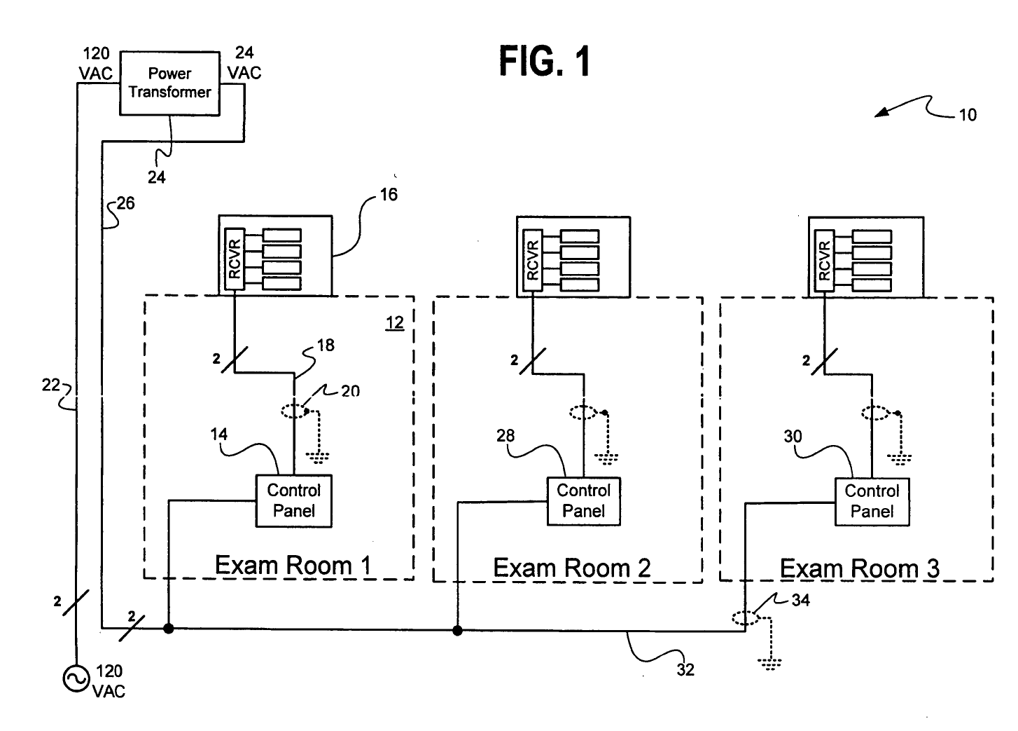

Turning now to the figures, where like elements are denoted by like reference numerals, FIG. 1 is a diagram of an exemplary dome light control system 10 in accordance with one embodiment of the present invention. The dome light control system 10 in FIG. 1 shows, located inside a patient's room 12, a control station 14 and connected to a dome light assembly 16 located outside the patient's room 12. The control station 14 is connected to the dome light assembly 16 by a two-wire cable 18 that may preferably be equipped with a shield 20.

Power to the control station 14 may originate in utility wiring 22, from which it may be fed from a central transformer 24 by low-voltage alternating-current wiring 26 serving preferably a multiplicity of control stations 14, 28 and 30 through power distribution wiring 32. Shielding 34 on all power distribution wiring 32 may likewise be desirable.

In the case of an unshielded system, a pair of loose wires, placed, for example, in a nonconductive conduit, can be used as signal conductors, and, in effect, comprise a transmission line. Such an arrangement can both radiate and capture stray electromagnetic interference (EMI) and radio-frequency interference (RFI) signals, and has the potential to cause signal and operational errors in highly sensitive electronic devices, such as medical instruments. The same pair of loose wires, placed within a metallic or otherwise conductive conduit, may exhibit lower interference, provided the conduit exhibits good electrical continuity to ground, since the conduit will tend to short out interference and thereby provide some shielding effect. This applies for most styles of conduit, such as flexible and rigid conduit.

Holding the pair of (untwisted) wires at uniform spacing, commonly characteristic of cables such as zip cord and Romex®, tends to increase impedance uniformity, reducing the tendency of the pair to radiate and to absorb signals. Twisting the wires together, as in commercial twisted pair cable, provides continuous change and periodic reversal in field orientation, which can tend to largely cancel both radiated emissions and induced interference. The most thorough protection against interference places a twisted pair within at least one layer of overall braided, stranded, or foil shield, which, if properly grounded, can provide a barrier to interference along with distributed interference cancellation, meanwhile providing good assurance of impedance uniformity.

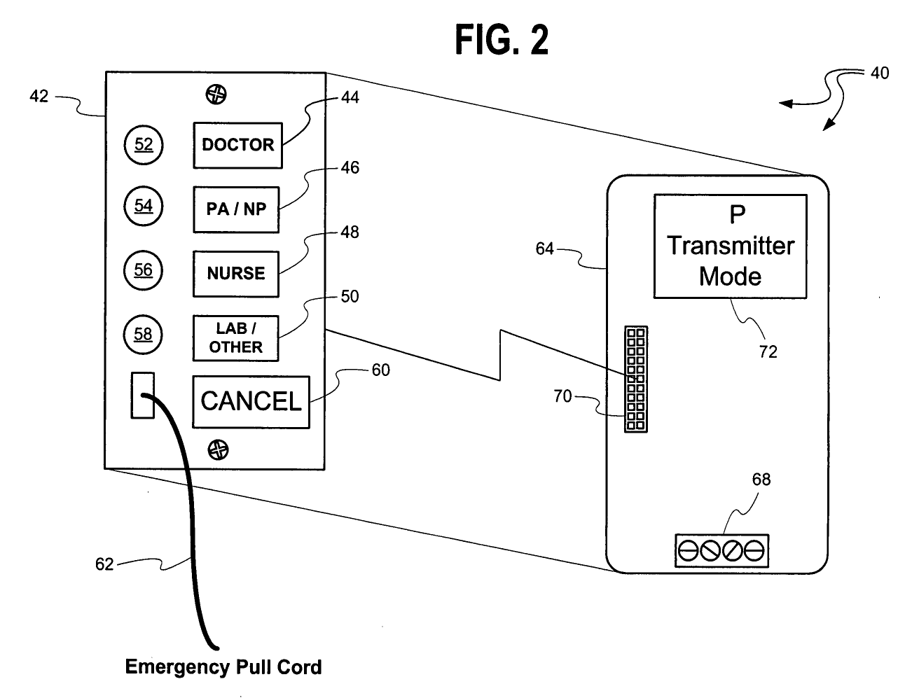

The control station 40, shown in greater detail in FIG. 2, may comprise a user interface 42 such as a series of pushbuttons 44-50, each of which is associated with a status display lamp 52-58. Such a control station 40 can further provide a single cancellation button 60 permitting all requests to be cleared at once and a lanyard-type emergency pull switch 62 that can be used with less requirement for operator precision. Alternate implementations can use lighted pushbuttons 44-50 and dispense with the provision of separate lamps 52-58. Each pushbutton 44-50 can be further enhanced, such as by allowing sequential presses to cycle button function through normal (constant on), flashing (such as 50% duty cycle at one on-off cycle per second or another desirable rate), and off, which capability may optionally allow omission of the cancellation button 60.

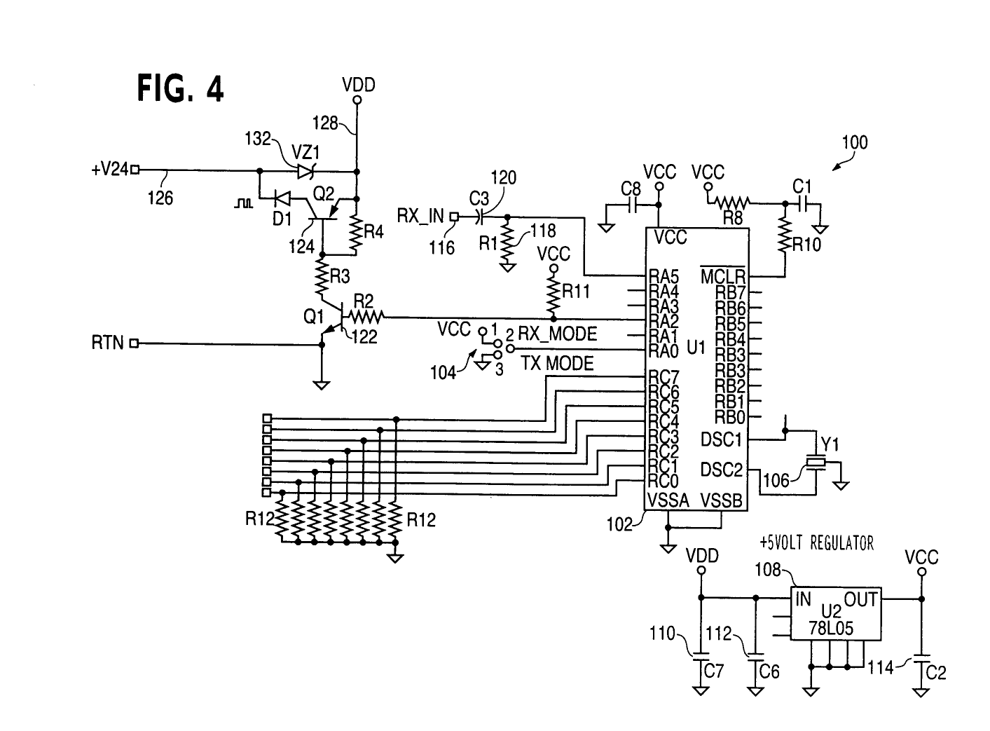

An internal face of the control station 40 also is shown in FIG. 2, wherein a circuit board 64 can be wired to incoming low-voltage AC and outgoing command power/signal at a terminal block or connector 68. The circuit board can establish a multiconductor interface to the user interface 42 of the control station 40 by a keypad connector 70. Among the circuit elements present on the circuit board 64 can be a transmitter microprocessor integrated circuit (IC) 72, the functionality of which is discussed below under FIG. 4.

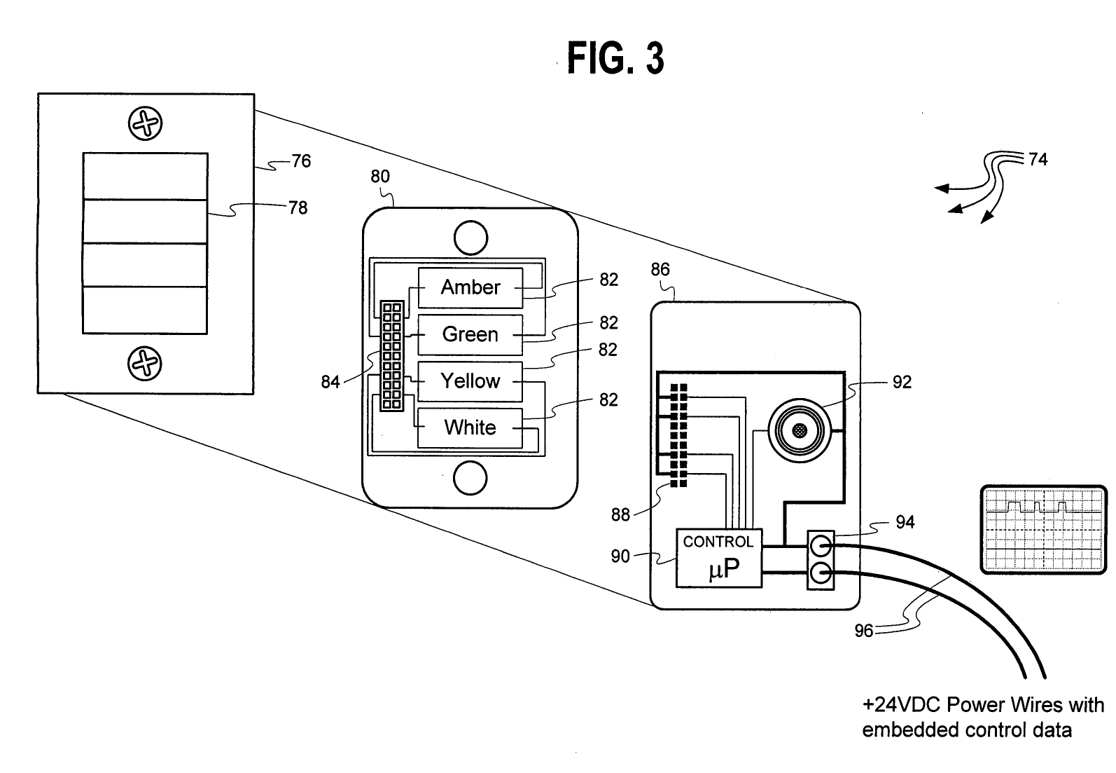

FIG. 3 shows a dome light 74. Like the control station 40, the dome light 74 includes an outer escutcheon plate 76, which may be equipped with a simple clear or fogged lens, a multiplicity of tinted lens segments, or an equivalent 78. Behind the escutcheon plate can be a circuit board 80 on which can be mounted a multiplicity of lamps such as light-emitting diode (LED) arrays 82. Such LED arrays 82 may provide sufficient brightness, power efficiency, and longevity to be preferable to previous technologies, such as neon and incandescent bulbs, which may be desirable in some applications. Alternative display technologies such as backlit liquid crystal displays (LCD) may also meet requirements for brightness, long life, and low power consumption. A stacking connector 84 is shown as an interface to a second circuit board 86. Behind the display carrier circuit board 80 in the exemplary dome light 74 is shown the second circuit board 86, using mating stacking connector 88, that can carry a receiver microprocessor 90 to receive serial digital signals transmitted from the control station 40 and interpret them as commands to light the displays 82 and/or to activate a sound generator 92. A dome light connector or terminal block 94 can provide interconnect to the pair of wires 96 feeding power and control to the dome light 74 from the control station 40.

FIG. 4 shows an exemplary circuit board communication section 100 in schematic form. This communication section 100 includes a microprocessor IC 102 that can be programmed as a transmitter or receiver using a direction jumper 104 that straps a control pin high or low. The microprocessor IC 102 includes a clock oscillator function that may be adequately well controlled with an RC network (not shown) or may preferably employ a crystal 106 to ensure that the sample rates will be tightly controlled. The exemplary microprocessor IC 102 may require a tightly regulated DC power supply at 3.3 volts, 5 volts, or another setting; a regulator 108 with associated decoupling and filter capacitors 110-114 can be included to provide the required power. Such a power supply 108 may be linear or switching; minimum complexity may recommend linear, while minimum power consumption may find a switching regulator preferable, some of which latter devices require inductors (not shown) to provide high efficiency and low parasitic noise.

A control station 40 may be powered, for example, from bussed, intrinsically safe power, such as the 24-volt transformer-isolated alternating-current power supplied from a central power supply 24 and distributed by low-voltage wiring 26 as shown in FIG. 1. Such power can be rectified and filtered with a diode-capacitor network including a bridge rectifier, for example (not shown), to provide unregulated direct current at roughly 24 volts, shown arriving at the exemplary transmitter section of the control station 40 on the +24 VDC input pin 128. This power can be adequate to drive the circuit board shown in part in FIG. 4, where it is jumpered to function as a transmitter, as well as to provide the power needed by a dome light assembly 72, which uses the same circuit board of FIG. 4 jumpered as a receiver and powered via the signal input pin 116. In the exemplary system, both output power and command signals to the dome light assembly 80 are provided on the 18-volt output pin 126, with the power dropped down from the unregulated 24-volt power using a zener diode 132 to provide signal swing for the command signals.

Input signals to a microprocessor 102 configured as a receiver (jumper 104 set high by a jumper between pins 1 and 2 thereof) may arrive on an input line 116, which line can be pulled low by a weak resistor 118 and permitted to swing high during positive-going signals by a coupling capacitor 120. Output signals from a microprocessor 102 configured as a transmitter (jumper 104 set low by a jumper between pins 2 and 3 thereof) can be configured to drive bipolar transistors 122 and 124 to force output line 126 high during each logic-1 interval, which intervals are determined by the internal processing of the transmitter microprocessor 102 and output from pin 4, named RA2, thereof. Output line 126 is pulled low by load current in the receiver microprocessor circuit driven by the transmitter-configured circuit, including quiescent current in the regulator IC of the dome light assembly and current drawn by any lamps illuminated in the control station 40 panel and the dome light assembly 80.

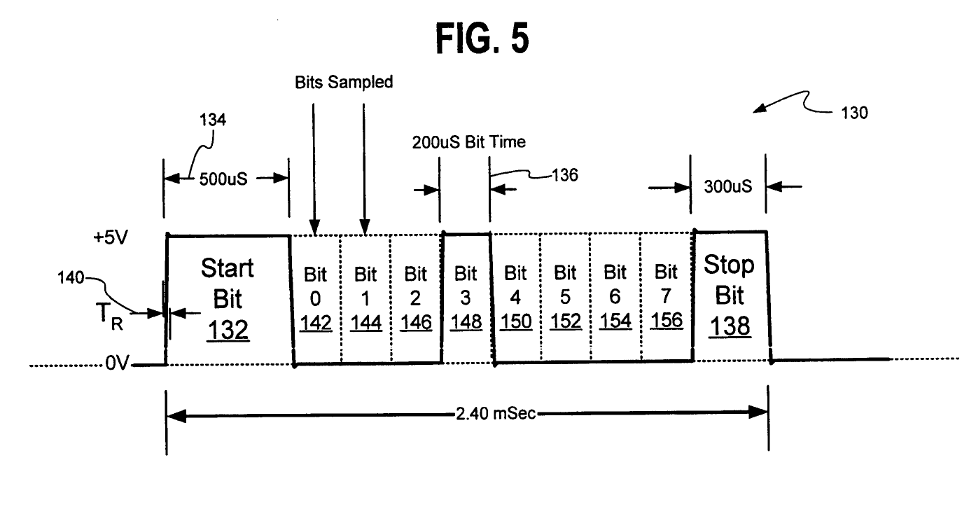

FIG. 5 shows a representative waveform 130, as generated within the transmitter circuit board and substantially as received by the receiver circuit board. This CMOS digital logic compatible signal can be sensed using edge or level triggering within the microprocessor IC 102 of a receiver circuit board according to FIG. 4 to start an internal timer that can be used to confirm that the start bit 132 has duration between suitable limits to confirm normal operation. In the exemplary system, a start bit duration of 500 microseconds is shown as nominal. A receiver circuit board microprocessor IC 102 that can operate significantly faster than this rate can sample the signal several times during the course of the start bit 132, verifying that the pulse duration 134 is correct within an established range, and thus confirming the identity of the pulse. Many other synchronizing schemes exist that can accomplish such start bit confirmation.

The signal timing indicated in the exemplary embodiment, shown in FIG. 5, is 500 microseconds for the start bit 132, 200 microseconds per data bit 136, and 300 microseconds for the stop bit 138. This signal timing is effective and adequate, but is not uniquely required for the invention. Transmitted signal rise time 140 need only be rapid enough to trigger an edge-triggered timer (not shown), a function located within the microprocessor IC 102 of FIG. 4, a speed requirement that can be obviated by the use of a level triggered timer (not shown) within the microprocessor IC 102 of FIG. 4. Similarly, successive data bits 142-156 may be of any known timing provided they are of sufficient duration to allow each bit to be stable in a state before sampling.

Once the start bit 132 has established timing, successive samples can be taken at the center of each successive bit time. In the exemplary waveform, which transmits the least significant bit (LSB) 142 first, only Bit 3 148 is active. This could correspond to a doctor call lamp being steadily lit, for example. Similarly, setting Bit 4 150 could correspond to an emergency, Bit 5 152 to activation of the sound generator, Bit 6 154 to flash all active lights, and Bit 7 156 to flash sequentially instead of simultaneously any lights enabled to flash by Bit 6 154.

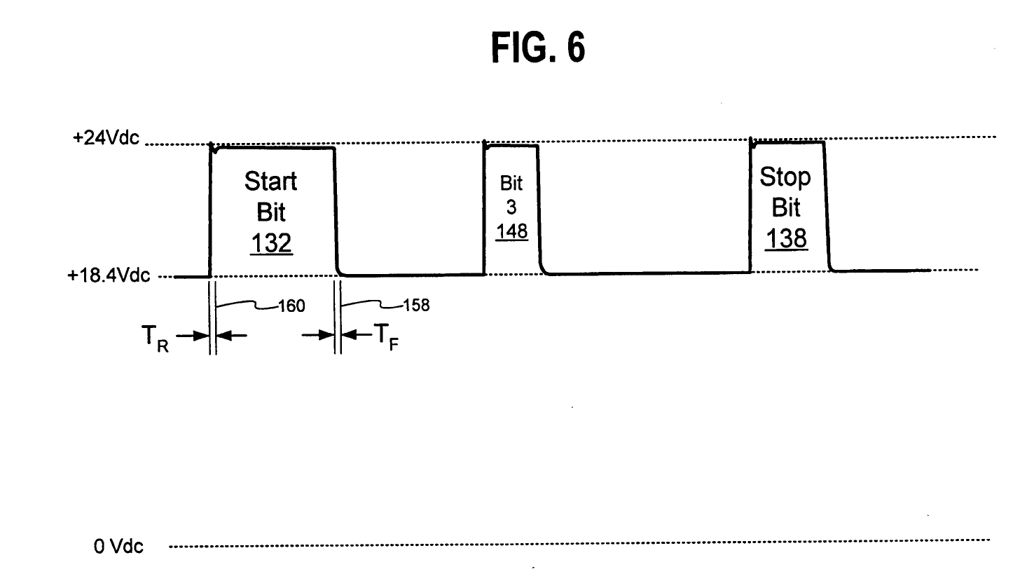

FIG. 6 shows the representative waveform of FIG. 5 as combined with DC receiver board power to appear on the output line 126 of FIG. 4. Timing and drive properties are substantially identical to those of the internal signals shown in FIG. 5, with the reduced pulldown capability of the exemplary open-collector configuration having little effect on falling-edge timing 158 and the increased drive of the exemplary bipolar transistor 124 having similarly slight net effect on rising-edge timing 160.

Other message formats are possible, such as the use of a longer command word, which could include assignment of more than the previously mentioned two bits, thereby permitting more state options for each lamp to be available. Another option could transmit, for example, a single message per lamp, comprising a lamp number and a command code. Another option could leave the transmitter with the burden of keeping track of display functions, and require the transmitter to send a new command word for each state change in the dome light. Thus, to emulate the above operation, a flashing doctor call would require a new command to be sent each half-second—first on, then, after a half-second wait, off—instead of sending a flashing-doctor-call command once.

Other electronic line drivers and receivers and their associated microprocessor ICs may be usable in place of the devices shown in FIG. 4. The exemplary configuration is single-ended, which can be adequate for short to moderate line lengths, while alternatives include differential drivers, which can be superior over longer lines.

Fiber optic communication may also be feasible, although the properties commonly viewed as making fiber desirable may be of limited benefit in the exemplary system. For example, fibers can be used to transmit the commands described above, and have the particular advantage of being effectively free of risk of causing interference in other medical apparatus in a room. Such approaches require separate power connections. Using another approach, light from high-brightness signal sources such as laser diodes, sent through low-loss fibers used as light pipes, can directly illuminate diffusers, so that neither electrical power nor active parts are required at the dome light unit.

Applications of the present invention can include support of multiple-station ward areas with multiple entrance doors. For such configurations, central timekeeping—that is, a single master clock to which all stations would be resynchronized periodically—may be preferable. Such synchronization, with microprocessor IC 102 transmitters programmed to start their respective transmissions only at specific intervals, may require bit transmit times to be uniform after a button is pressed at any station. Using the open-collector configuration of the output transistor 124 in FIG. 5, this approach may permit output from multiple transmitters on a single shared line. Multiple receivers operated in parallel can be used in such as system, with the number of receivers limited only by the available power.

The many features and advantages of the invention are apparent from the detailed specification, and, thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, that fall within the scope of the invention.

1. A dome light assembly, comprising:
a display;
a single pair of wires that transmit power and a control signal to said display; and
a receiver linked to said display by said single pair of wires, wherein said receiver is configured to activate said display in accordance with the control signal.

2. The dome light of claim 1, further comprising a transmitter configured to transmit said control signals to the receiver.

3. The dome light of claim 1, wherein said display is comprised of identifiably distinct display elements.

4. The dome light of claim 3, wherein said identifiably distinct display elements are individually activated.

5. The dome light of claim 1, wherein said display is driven by electric power.

6. The dome light of claim 3, wherein said identifiably distinct display elements of said display emit visible light when activated.

7. The dome light of claim 6, wherein the identifiably distinct display elements of said display device emit visible light in periodic flashes when activated.

8. The dome light of claim 7, wherein said periodic visible light flashes of said identifiably distinct display elements are emitted simultaneously.

9. The dome light of claim 7, wherein said periodic visible light flashes of said identifiably distinct display elements are emitted sequentially.

10. The dome light of claim 7, wherein individual ones of said identifiably distinct display elements may be individually commanded to be one of nonemissive, emitting flashes of light, or emitting light continuously.

11. The dome light of claim 6, wherein the visible light emitted by the identifiably distinct display elements when activated further comprises a selected color for each display element.

12. The dome light of claim 1, further comprising a sound emitter controlled by said receiver.

13. The dome light of claim 1, wherein said receiver is collocated with said display.

14. The dome light of claim 2, wherein said transmitter is physically remote from said receiver.

15. The dome light of claim 2, wherein said transmitter furnishes all of the electrical power consumed by said receiver and said display.

16. The dome light of claim 1, wherein said single pair of wires is shielded.

17. The dome light of claim 2, further comprising at least one nonpowered display capable of emitting light generated by and sent thereto from a transmitter, wherein the light is conducted thereto using at least one fiber optic light conductor.

18. A method of indicating the status of a room, comprising:
receiving control signals from a single pair of wires to activate a display device, wherein the single pair transmits both power and the control signals; and
activating the display device in accordance with the content of the control signals received.

19. The method of claim 18, further comprising transmitting the control signals from a control station.

20. A dome light system, comprising:
means for receiving a control signal and power from a single pair of wires; and
means for actuating a means for displaying in accordance with the content of the control signals received.

21. The system of claim 20, further comprising means for transmitting the control signals from a means for controlling.

22. A dome assembly, comprising:
a display;
a single pair of wires that transmits a control signal and power to the display;
a receiver linked to the display through the wires, the receiver configured to evaluate the control signal and activate the display in accordance with the control signal in at least one of a plurality of modes.
